(19) United States
(12) Patent Application Publication
(10) Pub. No.: US 2026/0227189 A1
(43) Pub. Date: Aug. 6, 2026

(54) ADVANCED SYSTEM OF VEHICLE FOULING DETECTION ON TRACK SIDINGS

(71) Applicant: Transportation IP Holdings, LLC, Norwalk, CT (US)

(72) Inventors: Sreejesh Karakkattillom Narayanan Nampoothiri, Bangalore (IN); Praful Babuji Vihol, Gaithersburg, MD (US)

(73) Assignee: Transportation IP Holdings, LLC, Norwalk, CT (US)

(21) Appl. No.: 19/046,449

(22) Filed: Feb. 5, 2025

(51) Int. Cl. G01C 21/28

(52) U.S. Cl. CPC G01C 21/28

(57) ABSTRACT

A method for determining whether a vehicle fully crossed a mark on a route is disclosed. The vehicle can include a leading end and a trailing end. The method can include collecting first and second navigation data corresponding to the leading and trailing end, respectively, as the vehicle travels along the route; determining the leading end crossed the mark on the route; extracting final navigation data from the collected first navigation data based on the determination that the leading end crossed the mark, the final navigation data corresponding to the leading end when the leading end crossed the mark; comparing the final navigation data to the collected second navigation data; and determining whether the vehicle fully crossed the mark based on a comparison of the final navigation data with a portion of the collected second navigation data.

### BACKGROUND

### Technical Field

The subject matter described herein relates to an advanced system of vehicle fouling detection on track sidings.

### Discussion of Art

Navigation accuracy for a vehicle's position on a route is essential for various applications such as toll collection, traffic management, parking systems, and boundary compliance monitoring. Traditional navigation systems may rely on simple sensors that only provide a binary indication of position, lacking the capability to accurately determine if a vehicle has crossed a specific location marker (or “mark”) or is positioned between two marks, or, when no marks are installed, has crossed a predetermined location or is positioned between two predetermined locations.

In various applications, vehicles (e.g., automobiles, rail vehicles, buses, trucks, mining vehicles, etc.), or vehicle systems, rely on marks (e.g., fouling marks) located along a route for various reasons. In a first example, a vehicle may rely on marks along a route to determine when a vehicle is safely positioned within a portion of the route. For example, a vehicle that exits a first route section (e.g., a main path) to a second route section (e.g., a siding path) may rely on a set of marks to determine when the vehicle is safely positioned within the second route section. In other words, the vehicle may rely on the set of marks to determine the vehicle is no longer extending onto the first route section. In a second example, a vehicle may rely on marks along a route to determine when a vehicle has entered, or exited, a speed restricted zone. In a third example, a vehicle may rely on marks along a route to determine when a vehicle shall be cautious of external factors that may affect the vehicle, or the route, such as, but not limited to, wildlife, falling rocks, or the like. It shall be appreciated that various other examples, or applications, may be readily apparent to one having ordinary skill in the art.

To ensure that a vehicle has fully crossed a mark on a route, or to ensure that a vehicle is positioned between a set of marks on a route, a vehicle, or vehicle system, may rely on a human crew member to determine, or confirm, that the vehicle has fully crossed the mark on the route, or to determine, or confirm, that the vehicle is positioned between a set of marks on a route. This determination, or confirmation, requires the human crew member to have a direct line of sight to the mark, or each mark of the set of marks, and further requires the human crew member to determine, or confirm, that the vehicle has fully crossed the mark on the route, or that the vehicle is positioned between the set of marks on the route. Additionally, or alternatively, a vehicle, or vehicle system, may rely on devices provided at various locations along the route, such as, for example, wayside devices.

Current methods, such as axle counters, for determining, or confirming, that the vehicle has fully crossed the mark on the route, or that the vehicle is positioned between the set of marks on the route, may rely on a human crew member who is exhausted, preoccupied, or the like. Additionally, these methods may require a human crew member to be exposed to extreme weather conditions such as, but not limited to, heavy rain, snow, or strong winds, which may additionally limit a visibility of the human crew member. Furthermore, these methods may additionally or alternatively rely on non-cost-effective methods, which are not onboard solutions. Accordingly, it may be desirable to provide an advanced system of vehicle fouling detection on track sidings that differs from existing systems of vehicle fouling detection on track sidings.

### BRIEF DESCRIPTION

In a first embodiment, a system for determining whether a vehicle has fully exited from a first route section to a second route section is disclosed. The vehicle can include a leading end and a trailing end. The system can include a first measurement device located at the leading end, a second measurement device located at the trailing end, and a control circuit communicably coupled to the first and second measurement devices. The control circuit can be configured to generate a first data pattern as the leading end exits the first route section and a second data pattern as the leading end enters the second route section. The first and second data patterns can be measured by the first measurement device and define orientation changes of the leading end. The control circuit can be further configured to generate a third data pattern as the trailing end exits the first route section and a fourth data pattern as the trailing end enters the second route section. The third and fourth data patterns can be measured by the second measurement device and define orientation changes of the trailing end. The control circuit can be further configured to determine whether the vehicle has fully exited from the first route section to the second route section based on a comparison of the third data pattern with the first data pattern and a comparison of the fourth data pattern with the second data pattern.

In one aspect of the first embodiment, the first measurement device can include a first gyroscope, and the second measurement device can include a second gyroscope. The first and second data patterns can include angle-of-turn data of the leading end, and the third and fourth data patterns can include angle-of-turn data of the trailing end.

In another aspect of the first embodiment, taken alone or in combination with any other aspect of the first embodiment, the system can further include an odometer located at the leading end. The control circuit can be further configured to generate a first baseline pattern as the leading end travels along the first route section. The first baseline data pattern can be measured by the first measurement device and define an orientation of the leading end on the first route section. The control circuit can be further configured to generate a second baseline data pattern as the trailing end travels along the first route section. The second baseline data pattern can be measured by the second measurement device and define an orientation of the trailing end on the first route section. The control circuit can be further configured to trigger the odometer to begin recording a distance traveled by the leading end based on the leading end transitioning from the first baselined data pattern to the first data pattern and from the first data pattern to the second data pattern. The control circuit can be further configured to trigger the odometer to stop recording the distance traveled by the leading end based on the trailing end transitioning from the second baseline data pattern to the third data pattern and from the third data pattern to the fourth data pattern. The control circuit can be further configured to compare the distance traveled by the leading end to a length of the second route section.

In another aspect of the first embodiment, taken alone or in combination with any other aspect of the first embodiment, the control circuit can be further configured to determine the distance traveled by the leading end is less than the length of the second route section based on the comparison of the distance traveled by the leading end to the length of the second route section. The control circuit can be further configured to initiate a full-service brake application to stop the vehicle based on the determination that the distance traveled by the leading end is less than the length of the second route section.

In another aspect of the first embodiment, taken alone or in combination with any other aspect of the first embodiment, the control circuit can be further configured to determine the distance traveled by the leading end is greater than the length of the second route section based on the comparison of the distance traveled by the leading end to the length of the second route section. The control circuit can be further configured to generate at least one of a visual warning or an audible warning based on the determination that the distance traveled by the leading end is greater than the length of the second route section. The at least one visual or audible warning can indicate that a length of the vehicle is greater than the length of the second route section.

In another aspect of the first embodiment, taken alone or in combination with any other aspect of the first embodiment, the control circuit can be further configured to generate a fifth data pattern as the leading end exits the second route section and a sixth data pattern as the leading end enters the first route section. The fifth and sixth data patterns can be measured by the first measurement device and define orientation changes of the leading end.

In another aspect of the first embodiment, taken alone or in combination with any other aspect of the first embodiment, the control circuit can be further configured to determine a length of the vehicle is greater than the length of the second route section based on the fifth and sixth data patterns being generated before the third and fourth data patterns. The control circuit can be further configured to generate at least one of a visual warning or an audible warning based on the determination that the length of the vehicle is greater than the length of the second route section. The at least one visual or audible warning can indicate that the length of the vehicle is greater than the length of the second route section.

In a second embodiment, a method for determining whether a vehicle has fully exited from a first route section to a second route section is disclosed. The vehicle can include a leading end and a trailing end. The method can include generating a first data pattern at the leading end as the leading end exits the first route section and a second data pattern at the leading end as the leading end enters the second route section. The first and second data patterns can define orientation changes of the leading end. The method can further include generating a third data pattern at the trailing end as the trailing end exits the first route section and a fourth data pattern at the trailing end as the trailing end enters the second route section. The third and fourth data patterns can define orientation changes of the trailing end. The method can further include determining whether the vehicle has fully exited from the first route section to the second route section based on a comparison of the third data pattern with the first data pattern and a comparison of the fourth data pattern with the second data pattern.

In one aspect of the second embodiment, the first and second data patterns can include angle-of-turn data of the leading end, and the third and fourth data patterns can include angle-of-turn data of the trailing end.

In another aspect of the second embodiment, taken alone or in combination with any other aspect of the second embodiment, the method can further include generating a first baseline data pattern as the leading end travels along the first route section. The first baseline data pattern can define an orientation of the leading end on the first route section. The method can further include generating a second baseline data pattern as the trailing end travels along the first route section. The second baseline data pattern can define an orientation of the trailing end on the first route section. The method can further include triggering an odometer located on the leading end to begin recording a distance traveled by the leading end based on the leading end transitioning from the first baseline pattern to the first data pattern and from the first data pattern to the second data pattern. The method can further include triggering the odometer to stop recording the distance traveled by the leading end based on the trailing end transitioning from the second baselined data pattern to the third data pattern and from the third data pattern to the fourth data pattern. The method can further include comparing the distance traveled by the leading end to a length of the second route section.

In another aspect of the second embodiment, taken alone or in combination with any other aspect of the second embodiment, the method can further include determining the distance traveled by the leading end is less than the length of the second route section based on the comparison of the distance traveled by the leading end to the length of the second route section. The method can further include initiating a full-service brake application to stop the vehicle based on the determination that the distance traveled by the leading end is less than the length of the second route section.

In another aspect of the second embodiment, taken alone or in combination with any other aspect of the second embodiment, the method can further include determining the distance traveled by the leading end is greater than the length of the second route section based on the comparison of the distance traveled by the leading end to the length of the second route section. The method can further include generating at least one of a visual warning or an audible warning based on the determination that the distance traveled by the leading end is greater than the length of the second route section. The at least one visual or audible warning can indicate that a length of the vehicle is greater than the length of the second route section.

In another aspect of the second embodiment, taken alone or in combination with any other aspect of the second embodiment, the method can further include generating a fifth data pattern as the leading end exits the second route section and a sixth data pattern as the leading end enters the first route section. The fifth and sixth data patterns can define orientation changes of the leading end.

In another aspect of the second embodiment, taken alone or in combination with any other aspect of the second embodiment, the method can further include determining a length of the vehicle is greater than the length of the second route section based on the fifth and sixth data patterns being generated before the third and fourth data patterns. The method can further include generating at least one of a visual warning or an audible warning based on the determination that the length of the vehicle is greater than the length of the second route section. The at least one visual or audible warning can indicate that the length of the vehicle is greater than the length of the second route section.

In a third embodiment, a method for broadcasting an alarm based on at least a portion of a vehicle being parked on a first route section is disclosed. The vehicle can include a leading end and a trailing end. The method can include determining the leading end has exited the first route section to a second route section based on a first generated data pattern and a second generated data pattern. The first and second generated data patterns can define orientation changes of the leading end as the leading end travels from the first route section to the second route section. The method can further include determining the trailing end is parked on the first route section based on a speed of the vehicle equaling zero before a third data pattern and a fourth data pattern are generated. The third and fourth data patterns can define orientation changes of the trailing end as the trailing end travels from the first route section to the second route section. The method can further include broadcasting an alarm based on the determination that the trailing end is parked on the first route section. The alarm can indicate the trailing end is parked on the first route section to at least one of an emergency service or an additional vehicle traveling along the first route section.

In one aspect of the third embodiment, the method can further include ending the broadcast based on the third and fourth data patterns being generated.

In another aspect of the third embodiment, taken alone or in combination with any other aspect of the third embodiment, the alarm can be an emergency signal configured to be transmitted to the at least one emergency service or additional vehicle traveling along the first route section.

In another aspect of the third embodiment, taken alone or in combination with any other aspect of the third embodiment, the emergency signal can include at least one of a Global Positioning System (GPS) location of the trailing end, a date of broadcast, a time of broadcast, a number of occupants of the vehicle, or a listing of freight onboard the vehicle.

In another aspect of the third embodiment, taken alone or in combination with any other aspect of the third embodiment, the alarm can be at least one of a visual warning or an audible warning. The at least one visual or audible warning can indicate the trailing end is parked on the first route section.

In another aspect of the third embodiment, taken alone or in combination with any other aspect of the third embodiment, the at least one visual or audible warning can be an SOS signal using Morse code.

In a fourth embodiment, a system for determining whether a vehicle has fully crossed a mark on a route is disclosed. The vehicle can include a leading and a trailing end. The system can include a first measurement device located at the leading end, a second measurement device located at the trailing end, and a control circuit communicably coupled to the first and second measurement devices. The control circuit can be configured to collect first navigation data corresponding to the leading end as the vehicle travels along the route. The first navigation data can be measured by the first measurement device. The control circuit can be further configured to collect second navigation data corresponding to the trailing end as the vehicle travels along the route. The second navigation data can be measured by the second measurement device. The control circuit can be further configured to determine the leading end crossed the mark on the route. The control circuit can be further configured to extract final navigation data from the collected first navigation data based on the determination that the leading end crossed the mark. The final navigation data can correspond to the leading end when the leading end crossed the mark. The control circuit can be further configured to compare the final navigation data to the collected second navigation data. The control circuit can be further configured to determine whether the vehicle has fully crossed the mark based on a comparison of the final navigation data with a portion of the collected second navigation data.

In one aspect of the fourth embodiment, the system can further include a rolling memory buffer. The control circuit can be further configured to store the first and second navigation data in the rolling memory buffer.

In another aspect of the fourth embodiment, taken alone or in combination with any other aspect of the fourth embodiment, the first navigation data can include at least one of spatial coordinates, a magnetic heading, a Global Positioning System (GPS) location, or a speed of the leading end as the vehicle travels along the route. The second navigation data can include at least one of spatial coordinates, a magnetic heading, a GPS location, or a speed of the trailing end as the vehicle travels along the route. The final navigation data can include at least one of spatial coordinates, a magnetic heading, a GPS location, or a speed of the leading end when the leading end crossed the mark.

In another aspect of the fourth embodiment, taken alone or in combination with any other aspect of the fourth embodiment, the control circuit can be further configured to compare the speed of the leading end as the vehicle travels along the route to the speed of the trailing end as the vehicle travels along the route to properly compare the final navigation data to the collected second navigation data.

In another aspect of the fourth embodiment, taken alone or in combination with any other aspect of the fourth embodiment, the system can further include at least one of a camera, a radio-frequency identification (RFID) device, a laser, an acoustic transducer, or a Global Positioning System (GPS) device. The determination that the leading end crossed the mark can be automatic based on the at least one camera, RFID device, laser, acoustic transducer, or GPS device determining that the leading end crossed the mark.

In another aspect of the fourth embodiment, taken alone or in combination with any other aspect of the fourth embodiment, the determination that the leading end crossed the mark can be manual based on a user determining that the leading end crossed the mark.

In another aspect of the fourth embodiment, taken alone or in combination with any other aspect of the fourth embodiment, the control circuit can be further configured to generate at least one of a visual alert or an audible alert based on the determination whether the vehicle has fully crossed the mark. The at least one visual or audible alert can indicate whether the vehicle has fully crossed the mark.

In a fifth embodiment, a method for determining whether a vehicle has fully crossed a mark on a route is disclosed. The vehicle can include a leading end and a trailing end. The method can include collecting first navigation data corresponding to the leading end as the vehicle travels along the route. The method can further include collecting second navigation data corresponding to the trailing end as the vehicle travels along the route. The method can further include determining the leading end crossed the mark on the route. The method can further include extracting final navigation data from the collected first navigation data based on the determination that the leading end crossed the mark. The final navigation data can correspond to the leading end when the leading end crossed the mark. The method can further include comparing the final navigation data to the collected second navigation data. The method can further include determining whether the vehicle has fully crossed the mark based on a comparison of the final navigation data with a portion of the collected second navigation data.

In one aspect of the fifth embodiment, the method can further include storing the first and second navigation data in a rolling memory buffer.

In another aspect of the fifth embodiment, taken alone or in combination with any other aspect of the fifth embodiment, the first navigation data can include at least one of spatial coordinates, a magnetic heading, a Global Positioning System (GPS) location, or a speed of the leading end as the vehicle travels along the route. The second navigation data can include at least one of spatial coordinates, a magnetic heading, a GPS location, or a speed of the trailing end as the vehicle travels along the route. The final navigation data can include at least one of spatial coordinates, a magnetic heading, a GPS location, or a speed of the leading end when the leading end crossed the mark.

In another aspect of the fifth embodiment, taken alone or in combination with any other aspect of the fifth embodiment, the method can further include comparing the speed of the leading end as the vehicle travels along the route to the speed of the trailing end as the vehicle travels along the route to properly compare the final navigation data to the collected second navigation data.

In another aspect of the fifth embodiment, taken alone or in combination with any other aspect of the fifth embodiment, determining that the leading end crossed the mark can be automatic based on at least one of a camera, a radio-frequency identification (RFID) device, a laser, an acoustic transducer, or a Global Positioning System (GPS) device determining that the leading end crossed the mark.

In another aspect of the fifth embodiment, taken alone or in combination with any other aspect of the fifth embodiment, determining that the leading end crossed the mark can be manual based on a user determining the leading end crossed the mark.

In another aspect of the fifth embodiment, taken alone or in combination with any other aspect of the fifth embodiment, the method can further include generating at least one of a visual alert or an audible alert based on the determination whether the vehicle has fully crossed the mark. The at least one visual or audible alert can indicate whether the vehicle has fully crossed the mark.

In a sixth embodiment, a method for determining whether a vehicle is positioned between a first mark on a route and a second mark on the route is disclosed. The vehicle can include a leading end and a trailing end. The method can include collecting first navigation data corresponding to the leading end as the vehicle travels along the route. The method can further include collecting second navigation data corresponding to the trailing end as the vehicle travels along the route. The method can further include extracting first mark navigation data from the collected first navigation data based on the leading end crossing the first mark. The first mark navigation data can correspond to the leading end when the leading end crossed the first mark. The method can further include comparing the first mark navigation data to the collected second navigation data. The method can further include determining whether the vehicle is positioned between the first and second marks based on a comparison of the first mark navigation data with a portion of the collected second navigation data and based on the comparison occurring before or after extracting second mark navigation data from the collected first navigation data based on the leading end crossing the second mark. The second mark navigation data can correspond to the leading end when the leading end crossed the second mark.

In one aspect of the sixth embodiment, the method can further include storing the first and second navigation data in a rolling memory buffer.

In another aspect of the sixth embodiment, taken alone or in combination with any other aspect of the sixth embodiment, the first navigation data can include at least one of spatial coordinates, a magnetic heading, a Global Positioning System (GPS) location, or a speed of the leading end as the vehicle travels along the route. The second navigation data can include at least one of spatial coordinates, a magnetic heading, a GPS location, or a speed of the trailing end as the vehicle travels along the route. The first mark navigation data can include at least one of spatial coordinates, a magnetic heading, a GPS location, or a speed of the leading end when the leading end crossed the first mark. The second mark navigation data can include at least one of spatial coordinates, a magnetic heading, a GPS location, or a speed of the leading end when the leading end crossed the first mark.

In another aspect of the sixth embodiment, taken alone or in combination with any other aspect of the sixth embodiment, the method can further include comparing the speed of the leading end as the vehicle travels along the route to the speed of the trailing end as the vehicle travels along the route to properly compare the first mark navigation data to the collected second navigation data.

In another aspect of the sixth embodiment, taken alone or in combination with any other aspect of the sixth embodiment, the method can further include generating at least one of a visual alert or an audible alert based on the determination whether the vehicle is positioned between the first and second marks. The at least one visual or audible alert can indicate whether the vehicle is positioned between the first and second marks.

In another aspect of the sixth embodiment, taken alone or in combination with any other aspect of the sixth embodiment, the method can further include determining the leading end crossed the first mark on the route. The determination that the leading end crossed the first mark on the route can be manual based on a user determining the leading end crossed the first mark or automatic based on at least one of a camera, a radio-frequency identification (RFID) device, a laser, an acoustic transducer, or a Global Positioning System (GPS) device determining the leading end crossed the first mark.

In a seventh embodiment, a system for determining whether a vehicle has fully exited from a first route section to a second route section and/or whether a vehicle has fully crossed a mark on a route is disclosed. The vehicle can include a leading end and a trailing end. The system can include a first measurement device located at the leading end, a second measurement device located at the trailing end, and a control circuit communicably coupled to the first and second measurement devices.

In one aspect of the seventh embodiment, the control circuit can be configured to generate a first data pattern as the leading end exits the first route section and a second data pattern as the leading end enters the second route section. The first and second data patterns can be measured by the first measurement device and define orientation changes of the leading end. The control circuit can be further configured to generate a third data pattern as the trailing end exits the first route section and a fourth data pattern as the trailing end enters the second route section. The third and fourth data patterns can be measured by the second measurement device and define orientation changes of the trailing end. The control circuit can be further configured to determine whether the vehicle has fully exited from the first route section to the second route section based on a comparison of the third data pattern with the first data pattern and a comparison of the fourth data pattern with the second data pattern.

In another aspect of the seventh embodiment, taken alone or in combination with any other aspect of the seventh embodiment, the first measurement device can include a first gyroscope, and the second measurement device can include a second gyroscope. The first and second data patterns can include angle-of-turn data of the leading end, and the third and fourth data patterns can include angle-of-turn data of the trailing end.

In another aspect of the seventh embodiment, taken alone or in combination with any other aspect of the seventh embodiment, the system can further include an odometer located at the leading end. The control circuit can be further configured to generate a first baseline pattern as the leading end travels along the first route section. The first baseline data pattern can be measured by the first measurement device and define an orientation of the leading end on the first route section. The control circuit can be further configured to generate a second baseline data pattern as the trailing end travels along the first route section. The second baseline data pattern can be measured by the second measurement device and define an orientation of the trailing end on the first route section. The control circuit can be further configured to trigger the odometer to begin recording a distance traveled by the leading end based on the leading end transitioning from the first baselined data pattern to the first data pattern and from the first data pattern to the second data pattern. The control circuit can be further configured to trigger the odometer to stop recording the distance traveled by the leading end based on the trailing end transitioning from the second baseline data pattern to the third data pattern and from the third data pattern to the fourth data pattern. The control circuit can be further configured to compare the distance traveled by the leading end to a length of the second route section.

In another aspect of the seventh embodiment, taken alone or in combination with any other aspect of the seventh embodiment, the control circuit can be further configured to determine the distance traveled by the leading end is less than the length of the second route section based on the comparison of the distance traveled by the leading end to the length of the second route section. The control circuit can be further configured to initiate a full-service brake application to stop the vehicle based on the determination that the distance traveled by the leading end is less than the length of the second route section.

In another aspect of the seventh embodiment, taken alone or in combination with any other aspect of the seventh embodiment, the control circuit can be further configured to determine the distance traveled by the leading end is greater than the length of the second route section based on the comparison of the distance traveled by the leading end to the length of the second route section. The control circuit can be further configured to generate at least one of a visual warning or an audible warning based on the determination that the distance traveled by the leading end is greater than the length of the second route section. The at least one visual or audible warning can indicate that a length of the vehicle is greater than the length of the second route section.

In another aspect of the seventh embodiment, taken alone or in combination with any other aspect of the seventh embodiment, the control circuit can be further configured to generate a fifth data pattern as the leading end exits the second route section and a sixth data pattern as the leading end enters the first route section. The fifth and sixth data patterns can be measured by the first measurement device and define orientation changes of the leading end.

In another aspect of the seventh embodiment, taken alone or in combination with any other aspect of the seventh embodiment, the control circuit can be further configured to determine a length of the vehicle is greater than the length of the second route section based on the fifth and sixth data patterns being generated before the third and fourth data patterns. The control circuit can be further configured to generate at least one of a visual warning or an audible warning based on the determination that the length of the vehicle is greater than the length of the second route section. The at least one visual or audible warning can indicate that the length of the vehicle is greater than the length of the second route section.

In another aspect of the seventh embodiment, taken alone or in combination with any other aspect of the seventh embodiment, the control circuit can be configured to collect first navigation data corresponding to the leading end as the vehicle travels along the route. The first navigation data can be measured by the first measurement device. The control circuit can be further configured to collect second navigation data corresponding to the trailing end as the vehicle travels along the route. The second navigation data can be measured by the second measurement device. The control circuit can be further configured to determine the leading end crossed the mark on the route. The control circuit can be further configured to extract final navigation data from the collected first navigation data based on the determination that the leading end crossed the mark. The final navigation data can correspond to the leading end when the leading end crossed the mark. The control circuit can be further configured to compare the final navigation data to the collected second navigation data. The control circuit can be further configured to determine whether the vehicle has fully crossed the mark based on a comparison of the final navigation data with a portion of the collected second navigation data.

In another aspect of the seventh embodiment, taken alone or in combination with any other aspect of the seventh embodiment, the system can further include a rolling memory buffer. The control circuit can be further configured to store the first and second navigation data in the rolling memory buffer.

In another aspect of the seventh embodiment, taken alone or in combination with any other aspect of the seventh embodiment, the first navigation data can include at least one of spatial coordinates, a magnetic heading, a Global Positioning System (GPS) location, or a speed of the leading end as the vehicle travels along the route. The second navigation data can include at least one of spatial coordinates, a magnetic heading, a GPS location, or a speed of the trailing end as the vehicle travels along the route. The final navigation data can include at least one of spatial coordinates, a magnetic heading, a GPS location, or a speed of the leading end when the leading end crossed the mark.

In another aspect of the seventh embodiment, taken alone or in combination with any other aspect of the seventh embodiment, the control circuit can be further configured to compare the speed of the leading end as the vehicle travels along the route to the speed of the trailing end as the vehicle travels along the route to properly compare the final navigation data to the collected second navigation data.

In another aspect of the seventh embodiment, taken alone or in combination with any other aspect of the seventh embodiment, the system can further include at least one of a camera, a radio-frequency identification (RFID) device, a laser, an acoustic transducer, or a Global Positioning System (GPS) device. The determination that the leading end crossed the mark can be automatic based on the at least one camera, RFID device, laser, acoustic transducer, or GPS device determining that the leading end crossed the mark.

In another aspect of the seventh embodiment, taken alone or in combination with any other aspect of the seventh embodiment, the determination that the leading end crossed the mark can be manual based on a user determining that the leading end crossed the mark.

In another aspect of the seventh embodiment, taken alone or in combination with any other aspect of the seventh embodiment, the control circuit can be further configured to generate at least one of a visual alert or an audible alert based on the determination whether the vehicle has fully crossed the mark. The at least one visual or audible alert can indicate whether the vehicle has fully crossed the mark.

### BRIEF DESCRIPTION OF THE DRAWINGS

The subject matter may be understood from reading the following description of non-limiting examples, with reference to the attached drawings, wherein below:

FIG. 1 illustrates a system for determining whether a vehicle having a leading end unit and a trailing end unit has fully exited from a first route section to a second route section, according to at least one example of the present disclosure;

FIG. 2 is a flow diagram of a method for determining whether a vehicle having a leading end unit and a trailing end unit has fully exited from a first route section to a second route section, according to at least one example of the present disclosure;

FIG. 3 is a flow diagram of a method for broadcasting an alarm based on at least a portion of a vehicle having a leading end unit and a trailing end unit being parked on a first route section, according to at least one example of the present disclosure;

FIG. 4 illustrates an example route section having a first route section and a second route section, according to at least one example of the present disclosure;

FIG. 5 illustrates a system for determining whether a vehicle having a leading end unit and a trailing end unit has fully crossed a mark on a route, according to at least one example of the present disclosure;

FIG. 6 is a flow diagram of a method for determining whether a vehicle having a leading end unit and a trailing end unit has fully crossed a mark on a route, according to at least one example of the present disclosure;

FIG. 7 is a flow diagram of a method for determining whether a vehicle having a leading end unit and a trailing end unit is positioned between a first mark on a route and a second mark on the route, according to at least one example of the present disclosure;

FIG. 8 illustrates an example route section having a first mark and a second mark, according to at least one example of the present disclosure; and

FIG. 9 illustrates an example route section having a first route section and a second route section, the second route section having a first mark and a second mark, according to at least one example of the present disclosure.

### DETAILED DESCRIPTION

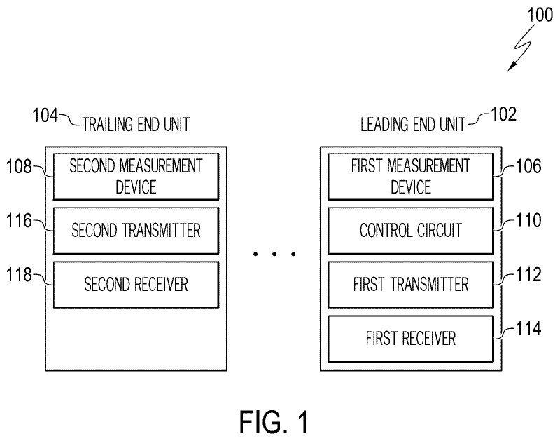

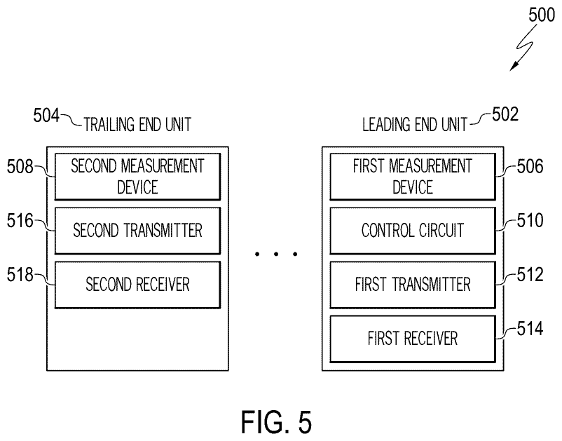

Embodiments of the subject matter described herein relate to a siding assistance system and an advanced system of vehicle fouling detection on track sidings. Specifically, FIGS. 1-4 and related text describe examples, and combinations thereof, relating to a siding assistance system, and methods thereof, while FIGS. 5-9 and related text describe examples, and combinations thereof, relating to an advanced system of vehicle fouling detection on track sidings, and methods thereof.

As previously discussed, current systems and methods for determining whether a vehicle has fully exited from a first route section to a second route section, determining whether a vehicle has fully crossed a mark on the route, and determining whether a vehicle is positioned between a set of marks on a route may rely on a human crew member who is exhausted, preoccupied, or the like. Additionally, these current systems and methods may require a human crew member to be exposed to extreme weather conditions. Furthermore, these current systems and methods may require trackside, or wayside, circuitry, which is not cost-effective. As such, it may be desirable to provide systems and methods which may not require a human crew member for a determination, and which may not require trackside, or wayside, circuitry.

Accordingly, embodiments of the systems and methods as set forth herein may be configured to determine whether a vehicle has fully exited from a first route section to a second route section, broadcast an alarm based on at least a portion of a vehicle being parked on a first route section, determine whether a vehicle has fully crossed a mark on a route, and determine whether a vehicle is positioned between a first mark on a route and a second mark on the route without requiring a human crew member and/or trackside, or wayside, circuitry.

Referring now to FIGS. 1-4, FIG. 1 illustrates a system 100 for determining whether a vehicle having a leading end unit 102, also referred to herein as a leading end, and a trailing end unit 104, also referred to herein as a trailing end, has fully exited from a first route section to a second route section, according to at least one example of the present disclosure. The system may include a first measurement device 106 located at the leading end unit, a second measurement device 108 located at the trailing end unit, and a control circuit 110 communicably coupled to the first and second measurement devices. As shown in FIG. 1, the control circuit may be located at the leading end unit, according to at least one example of the present disclosure. However, according to at least one example of the present disclosure, the control circuit may be located elsewhere on the vehicle or, alternatively, off-vehicle at a remote location. The system may further include a first transmitter 112 and a first receiver 114 located at the leading end unit, and a second transmitter 116 and a second receiver 118 located at the trailing end unit. Altogether, the first transmitter, the first receiver, the second transmitter, and the second receiver may facilitate communication between the leading end unit and the trailing end unit, and, specifically, the first measurement device and the second measurement device. Additionally, or alternatively, the first transmitter, the first receiver, the second transmitter, and the second receiver may facilitate communication between the leading end unit (e.g., the first measurement device), the trailing end unit (e.g., the second measurement device), and the control circuit.

According to at least one example of the present disclosure, the control circuit may be configured to generate a first data pattern as the leading end unit exits the first route section and a second data pattern as the leading end unit enters the second route section. The first and second data patterns may be measured by the first measurement device, and the first and second data patterns may define orientation changes of the leading end unit. The control circuit may be further configured to generate a third data pattern as the trailing end unit exits the first route section and a fourth data pattern as the trailing end unit enters the second route section. The third and fourth data patterns may be measured by the second measurement device, and the second and third data patterns may define orientation changes of the trailing end unit. The control circuit may be further configured to determine whether the vehicle has fully exited from the first route section to the second route section based on a comparison of the third data pattern with the first data pattern and a comparison of the fourth data pattern with the second data pattern.

According to at least one example of the present disclosure, the control circuit may include an integrated circuit, a general-purpose computing device, one or more processors, a memory device (e.g., forms of random-access memory), a communications device (e.g., a modem, communications switch, or optical-electrical equipment).

The control circuit described herein may have a local data collection system deployed and may use machine learning to enable derivation-based learning outcomes. The control circuit may learn from and make decisions on a set of data (including data provided by various sensors), by making data-driven predictions and adapting according to the set of data. According to at least one example of the present disclosure, machine learning may involve performing a plurality of machine learning tasks by machine learning systems, such as supervised learning, unsupervised learning, and reinforcement learning. Supervised learning may include presenting a set of example inputs and desired outputs to the machine learning systems. Unsupervised learning may include the learning algorithm structuring its input by methods such as pattern detection and/or feature learning. Reinforcement learning may include the machine learning systems performing in a dynamic environment and then providing feedback about correct and incorrect decisions. According to at least one example of the present disclosure, machine learning may include a plurality of other tasks based on an output of the machine learning system. According to at least one example of the present disclosure, the tasks may be machine learning problems such as classification, regression, clustering, density estimation, dimensionality reduction, anomaly detection, and the like. According to at least one example of the present disclosure, machine learning may include a plurality of mathematical and statistical techniques. According to at least one example of the present disclosure, the many types of machine learning algorithms may include decision tree based learning, association rule learning, deep learning, artificial neural networks, genetic learning algorithms, inductive logic programming, support vector machines (SVMs), Bayesian network, reinforcement learning, representation learning, rule-based machine learning, sparse dictionary learning, similarity and metric learning, learning classifier systems (LCS), logistic regression, random forest, K-Means, gradient boost, K-nearest neighbors (KNN), a priori algorithms, and the like. According to at least one example of the present disclosure, certain machine learning algorithms may be used (e.g., for solving both constrained and unconstrained optimization problems that may be based on natural selection). According to at least one example of the present disclosure, the algorithm may be used to address problems of mixed integer programming, where some components restricted to being integer-valued. Algorithms and machine learning techniques and systems may be used in computational intelligence systems, computer vision, Natural Language Processing (NLP), recommender systems, reinforcement learning, building graphical models, and the like. According to at least one example of the present disclosure, machine learning may be used making determinations, calculations, comparisons and behavior analytics, and the like.

According to at least one example of the present disclosure, the control circuit may include a policy engine that may apply one or more policies. These policies may be based at least in part on characteristics of a given item of equipment or environment. With respect to control policies, a neural network can receive input of a number of environmental and task-related parameters. These parameters may include, for example, operational input regarding operating equipment, data from various sensors, location and/or position data, and the like. The neural network can be trained to generate an output based on these inputs, with the output representing an action or sequence of actions that the equipment or system should take to accomplish the goal of the operation. During operation of at least one example of the present disclosure, a determination can occur by processing the inputs through the parameters of the neural network to generate a value at the output node designating that action as the desired action. This action may translate into a signal that causes the vehicle to operate. This may be accomplished via back-propagation, feed forward processes, closed loop feedback, or open loop feedback. Alternatively, rather than using backpropagation, the machine learning system of the control circuit may use evolution strategies techniques to tune various parameters of the artificial neural network. The control circuit may use neural network architectures with functions that may not always be solvable using backpropagation, for example functions that are non-convex. According to at least one example of the present disclosure, the neural network has a set of parameters representing weights of its node connections. A number of copies of this network are generated and then different adjustments to the parameters are made, and simulations are done. Once the output from the various models is obtained, they may be evaluated on their performance using a determined success metric. The best model is selected, and the vehicle control circuit executes that plan to achieve the desired input data to mirror the predicted best outcome scenario. Additionally, the success metric may be a combination of the optimized outcomes, which may be weighed relative to each other.

According to at least one example of the present disclosure, the first measurement device may include a first gyroscope and the first and second data patterns may include angle-of-turn data of the leading end unit. Additionally, the second measurement device may include a second gyroscope and the third and fourth data patterns may include angle-of-turn data of the trailing end unit. However, according to at least one example of the present disclosure, the first and second measurement devices may additionally or alternatively include a device, or devices, configured to record at least one of spatial coordinates, a magnetic heading, a Global Positioning System (GPS) location, a speed, or the like of the leading and trailing end units, respectively. As a result, the first and second data patterns may additionally or alternatively include at least one of spatial coordinates, a magnetic heading, a GPS location, a speed, or the like of the leading end unit, and the third and fourth data patterns may additionally or alternatively include at least one of spatial coordinates, a magnetic heading, a GPS location, a speed, or the like of the trailing end unit.

According to at least one example of the present disclosure, the system may further include an odometer located at the leading end unit. Alternatively, and according to at least one example of the present disclosure, the odometer may be located elsewhere on the vehicle so long as the odometer records a distance traveled by the leading end unit. The control circuit may be further configured to generate a first baseline data pattern as the leading end unit travels along the first route section. The first baseline data pattern may be measured by the first measurement device, and the first baseline data pattern may define an orientation of the leading end unit on the first route section. The control circuit may be further configured to generate a second baseline data pattern as the trailing end unit travels along the first route section. The second baseline data pattern may be measured by the second measurement device, and the second baseline data pattern may define an orientation of the trailing end unit on the first route section. The control circuit may be further configured to trigger the odometer to begin recording a distance traveled by the leading end unit based on the leading end unit transitioning from the first baseline data pattern to the first data pattern and from the first data pattern to the second data pattern. The control circuit may be further configured to stop recording the distance traveled by the leading end unit based on the trailing end unit transitioning from the second baseline data pattern to the third data pattern and from the third data pattern to the fourth data pattern. The control circuit may be further configured to compare the distance traveled by the leading end unit to a length of the second route section.

According to at least one example of the present disclosure, the control circuit may be further configured to determine the distance traveled by the leading end unit is less than the length of the second route section based on the comparison of the distance traveled by the leading end unit with the length of the second route section. Based on the determination that the distance traveled by the leading end unit is less than the length of the second route section, the control circuit may be further configured to initiate a full-service brake application to stop the vehicle. Additionally, or alternatively, and according to at least one example of the present disclosure, the control circuit may be further configured to initiate a parking service, or the like, to park the vehicle based on the determination that the distance traveled by the leading end unit is less than the length of the second route section.

According to at least one example of the present disclosure, the control circuit may be further configured to determine the distance traveled by the leading unit is greater than the length of the second route section based on the comparison of the distance traveled by the leading end unit with the length of the second route section. Based on the determination that the distance traveled by the leading end unit is greater than the length of the second route section, the control circuit may be further configured to generate at least one of a visual warning or an audible warning, where the at least one visual or audible warning may indicate a length of the vehicle is greater than the length of the second route section. The visual warning, for example, may include illuminating a light bulb, such as a colored light bulb. The visual warning, for example, may additionally or alternatively include displaying a color block or text on a display available to a user, such as an operator, an engineer, or the like, located onboard the vehicle or at a remote location capable of controlling the vehicle. The audible warning, for example, may include voiceover announcing the distance traveled by the leading end unit is greater than the length of the second route section. It shall be appreciated that various other visual and audible warnings may be readily apparent to one having ordinary skill in the art and, thus, may be implemented into the system of FIG. 1 to indicate the distance traveled by the leading end unit is greater than the length of the second route section.

According to at least one example of the present disclosure, the control circuit may be further configured to generate a fifth data pattern as the leading end unit exits the second route section and a sixth data pattern as the leading end unit enters the first route section. The fifth and sixth data patterns may be measured by the first measurement device, and the fifth and sixth data patterns may define orientation changes of the leading end unit. The control circuit may be further configured to determine a length of the vehicle is greater than the length of the second route section based on the fifth and sixth data patterns being generated before the third and fourth data patterns. Based on the determination that the length of the vehicle is greater than the length of the second route section, the control circuit may be further configured to generate at least one of a visual warning or an audible warning, such as those provided above in the present disclosure, where the at least one visual or audible warning may indicate the length of the vehicle is greater than the length of the second route section.

According to at least one example of the present disclosure, the fifth and sixth data patterns may include angle-of-turn data of the leading end unit. However, according to at least one example of the present disclosure, the fifth and sixth data patterns may additionally or alternatively include at least one of spatial coordinates, a magnetic heading, a GPS location, a speed, or the like of the leading end unit.

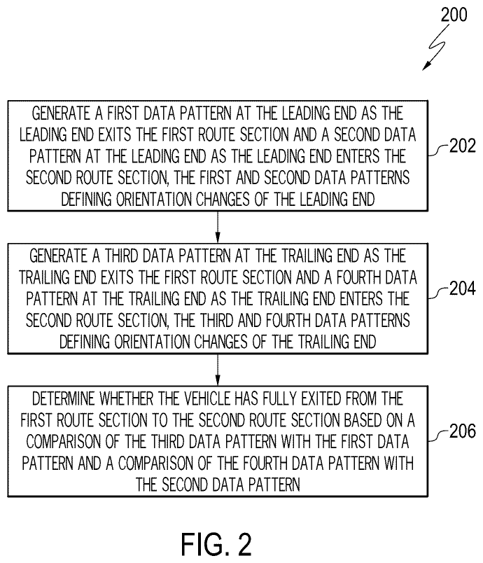

FIG. 2 is a flow diagram of a method 200 for determining whether a vehicle having a leading end unit, also referred to herein as a leading end, and a trailing end unit, also referred to herein as a trailing end, has fully exited from a first route section to a second route section, according to at least one example of the present disclosure. The method may include generating 202 a first data pattern at the leading end unit as the leading end unit exits the first route section and a second data pattern at the leading end unit as the leading end unit enters the second route section. The first and second data patterns may define orientation changes of the leading end unit. The method may further include generating 204 a third data pattern at the trailing end unit as the trailing end unit exits the first route section and a fourth data pattern at the trailing end unit as the trailing end unit enters the second route section. The third and fourth data patterns may define orientation changes of the trailing end unit. The method may further include determining 206 whether the vehicle has fully exited from the first route section to the second route section based on a comparison of the third data pattern with the first data pattern and a comparison of the fourth data pattern with the second data pattern.

According to at least one example of the present disclosure, the first and second data patterns may include angle-of-turn data of the leading end unit. Additionally, the third and fourth data patterns may include angle-of-turn data of the trailing end unit. However, according to at least one example of the present disclosure, the first and second data patterns may additionally or alternatively include at least one of spatial coordinates, a magnetic heading, a GPS location, a speed, or the like of the leading end unit, and the third and fourth data patterns may additionally or alternatively include at least one of spatial coordinates, a magnetic heading, a GPS location, a speed, or the like of the trailing end unit.

According to at least one example of the present disclosure, the method may further include generating a first baseline data pattern as the leading end unit travels along the first route section. The first baseline data pattern may define an orientation of the leading end unit on the first route section. The method may further include generating a second baseline data pattern as the trailing end unit travels along the first route section. The second baseline data pattern may define an orientation of the trailing end unit on the first route section. The method may further include triggering an odometer located on the leading end unit, or elsewhere on the vehicle, to begin recording a distance traveled by the leading end unit based on the leading end unit transitioning from the first baseline data pattern to the first data pattern and from the first data pattern to the second data pattern. The method may further include triggering the odometer to stop recording the distance traveled by the leading end unit based on the trailing end unit transitioning from the second baseline data pattern to the third data pattern and from the third data pattern to the fourth data pattern. The method may further include comparing the distance traveled by the leading end unit to a length of the second route section.

According to at least one example of the present disclosure, the method may further include determining the distance traveled by the leading end unit is less than the length of the second route section based on the comparison of the distance traveled by the leading end unit with the length of the second route section. Based on the determination that the distance traveled by the leading end unit is less than the length of the second route section, the method may further include initiating a full-service brake application to stop the vehicle. Additionally, or alternatively, and according to at least one example of the present disclosure, the method may further include initiating a parking service, or the like, to park the vehicle based on the determination that the distance traveled by the leading end unit is less than the length of the second route section.

According to at least one example of the present disclosure, the method may further include determining the distance traveled by the leading unit is greater than the length of the second route section based on the comparison of the distance traveled by the leading end unit with the length of the second route section. Based on the determination that the distance traveled by the leading end unit is greater than the length of the second route section, the method may further include generating at least one of a visual warning or an audible warning, such as those provided above in the present disclosure, where the at least one visual or audible warning may indicate a length of the vehicle is greater than the length of the second route section.

According to at least one example of the present disclosure, the method may further include generating a fifth data pattern at the leading end unit as the leading end unit exits the second route section and a sixth data pattern at the leading end unit as the leading end unit enters the first route section. The fifth and sixth data patterns may define orientation changes of the leading end unit. The method may further include determining a length of the vehicle is greater than the length of the second route section based on the fifth and sixth data patterns being generated before the third and fourth data patterns. Based on the determination that the length of the vehicle is greater than the length of the second route section, the method may further include generating at least one of a visual warning or an audible warning, such as those provided above in the present disclosure, where the at least one visual or audible warning may indicate the length of the vehicle is greater than the length of the second route section.

According to at least one example of the present disclosure, the fifth and sixth data patterns may include angle-of-turn data of the leading end unit. However, according to at least one example of the present disclosure, the fifth and sixth data patterns may additionally or alternatively include at least one of spatial coordinates, a magnetic heading, a GPS location, a speed, or the like of the leading end unit.

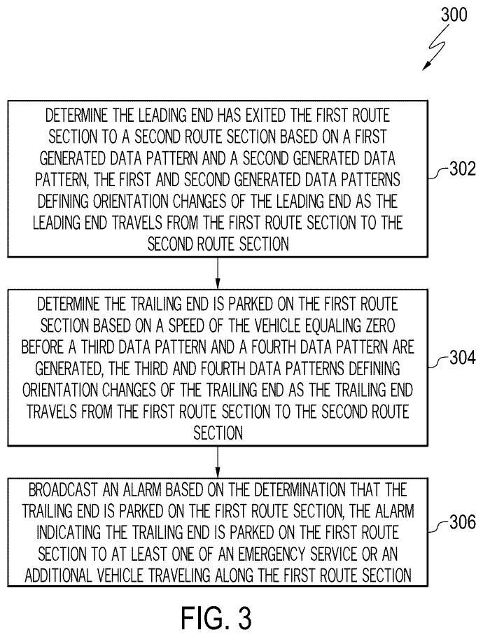

FIG. 3 is a flow diagram of a method 300 for broadcasting an alarm based on at least a portion of a vehicle having a leading end unit, also referred to herein as a leading end, and a trailing end unit, also referred to herein as a trailing end, being parked on a first route section, according to at least one example of the present disclosure. The method may include determining 302 the leading end unit has exited the first route section to a second route section based on a first generated data pattern and a second generated data pattern. The first and second generated data patterns may define orientation changes of the leading end unit as the leading end unit travels from the first route section to the second route section. The method may further include determining 304 the trailing end unit is parked on the first route section based on a speed of the vehicle equaling zero before a third data pattern and a fourth data pattern are generated. The third and fourth data patterns may define orientation changes of the trailing end unit as the trailing end unit travels from the first route section to the second route section. The method may further include broadcasting 306 an alarm based on the determination that the trailing end unit is park on the first route section. The alarm may indicate the trailing end unit is parked on the first route section to at least one of an emergency service or an additional vehicle traveling along the first route section.

According to at least one example of the present disclosure, the first and second generated data patterns may include angle-of-turn data of the leading end unit. Additionally, the third and fourth data patterns may include angle-of-turn data of the trailing end unit. However, according to at least one example of the present disclosure, the first and second generated data patterns may additionally or alternatively include at least one of spatial coordinates, a magnetic heading, a GPS location, a speed, or the like of the leading end unit, and the third and fourth data patterns may additionally or alternatively include at least one of spatial coordinates, a magnetic heading, a GPS location, a speed, or the like of the trailing end unit.

According to at least one example of the present disclosure, the method may further include ending the broadcast based on the third and fourth data patterns being generated.

According to at least one example of the present disclosure, the alarm may be an emergency signal configured to be transmitted to the at least one emergency service or additional vehicle traveling along the first route section. The emergency signal may include at least one of a GPS location of the trailing end unit, a date of broadcast, a time of broadcast, a number of occupants of the vehicle, or a listing of freight onboard the vehicle.

According to at least one example of the present disclosure, the alarm may be at least one of a visual warning or an audible warning, where the at least one visual or audible warning may indicate the trailing end unit is parked on the first route section. The visual warning, for example, may include illuminating a light bulb, such as a colored light bulb, located at the trailing end unit, or elsewhere on the vehicle. The audible warning, for example, may include activating a horn, or the like, of the vehicle. According to at least one example of the present disclosure, the at least one visual or audible warning may be an SOS signal using Morse code. For example, a light bulb may be illuminated in such a fashion to represent an SOS signal using Morse code, or a horn may be activated in such a fashion to represent an SOS signal using Morse code.

According to at least one example of the present disclosure, the control circuit of FIG. 1 may be configured to perform each of the functions of the method of FIG. 2, each of the functions of the method of FIG. 3, or any combinations thereof.

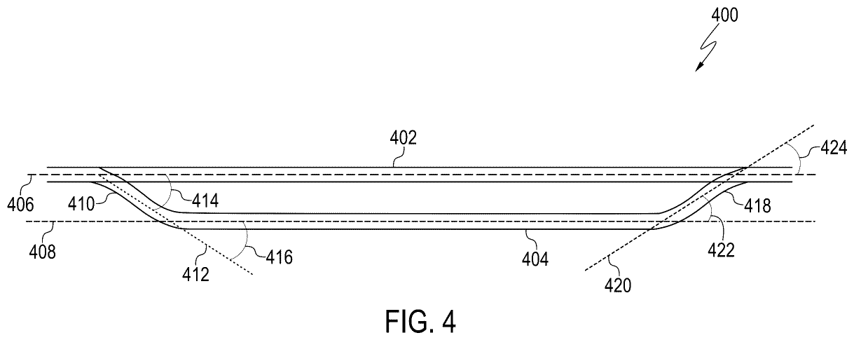

FIG. 4 illustrates an example route section 400 having a first route section 402 and a second route section 404, according to at least one example of the present disclosure. As shown in FIG. 4, the first route section may extend along a first axis 406 and the second route section may extend along a second axis 408. According to at least one example of the present disclosure, and as shown in FIG. 4, the second axis may be substantially parallel to the first axis. However, according to at least one example of the present disclosure, the second axis may not be substantially parallel to the first axis. As further shown in FIG. 4, an entry portion 410 may extend along a third axis 412, and the third axis may be positioned at a first angle 414 relative to the first axis and a second angle 416 relative to the second axis. As further shown in FIG. 4, an exit portion 418 may extend along a fourth axis 420, and the fourth axis may be positioned at a third angle 422 relative to the second axis and a fourth angle 424 relative to the first axis.

According to at least one example of the present disclosure, and because the second axis may be substantially parallel to the first axis as shown in FIG. 4, the absolute value of the first angle may be equal to the absolute value of the second angle. Similarly, the absolute value of the third angle may be equal to the absolute value of the fourth angle. However, according to at least one example of the present disclosure, and because the second axis may not be substantially parallel to the first axis, the absolute value of the first angle may not be equal to the absolute value of the second angle. Similarly, the absolute value of the third angle may not be equal to the absolute value of the fourth angle.

In a first practical application, and according to at least one example of the present disclosure, a vehicle may travel along the first route section without entering the second route section. However, in a second practical application, and according to at least one example of the present disclosure, a vehicle may travel along the first route section, enter the second route section via the entry portion, travel along the second route section, exit the second route section via the exit portion, and travel along the first route section.

Referring again to FIGS. 1 and 2, with continued reference to FIG. 4, and according to at least one example of the present disclosure, generating a first data pattern may include recording angle-of-turn data, such as the first angle, as the leading end unit exits the first route section, and generating a second data pattern may include recording angle-of-turn data, such as the second angle, as the leading end unit enters the second route section. Additionally, generating a third data pattern may include recording angle-of-turn data, such as the first angle, as the trailing end unit exits the first route section, and generating a fourth data pattern may include recording angle-of-turn data, such as the second angle, as the trailing end unit enters the second route section. Furthermore, generating a fifth data pattern may include recording angle-of-turn data, such as the third angle, as the leading end unit exits the second route section, and generating a sixth data pattern may include recording angle-of-turn data, such as the fourth angle, as the leading end unit enters the first route section.

Referring again to FIGS. 1 and 2, with continued reference to FIG. 4, and according to at least one example of the present disclosure, determining whether the vehicle has fully exited from the first route section to the second route section may include determining if a substantial match is found between the third and first data patterns and between the fourth and second data patterns. For example, if the third and first data patterns are a substantial match (e.g., substantially the same), an operator, an engineer, or the like will understand the trailing end unit has fully exited the first route section similar to the leading end unit. Similarly, for example, if the fourth and second data patterns are a substantial match (e.g., substantially the same), an operator, an engineer, or the like will understand the trailing end unit has entered the second route section similar to the leading end unit. Thus, if the third and first data patterns are a substantial match and the fourth and second data patterns are a substantial match, an operator, an engineer, or the like will understand that the vehicle has fully exited from the first route section to the second route section.

Referring again to FIG. 3, with continued reference to FIG. 4, and according to at least one example of the present disclosure, determining the leading end unit has exited the first route section to a second route section may include recording angle-of-turn data, such as the first angle and the second angle, as the leading end unit exits the first route section and enters the second route section. Additionally, determining the trailing end unit is parked on the first route section may include determining a speed of the vehicle is equal to zero before a third data pattern, such as the first angle, and a fourth data pattern, such as the second angle, are recorded at the trailing end unit. Furthermore, a broadcasted alarm may be ended, or stopped, based on the third data pattern, such as the first angle, and the fourth data pattern, such as the second angle, being generated at the trailing end unit.

Although FIG. 4 illustrates an example route section having a specific geometry, it shall be appreciated that the system of FIG. 1 and the methods of FIGS. 2 and 3 may be applicable to any geometry of any route section.

Referring now to FIGS. 5-9, FIG. 5 illustrates a system 500 for determining whether a vehicle having a leading end unit 502, also referred to herein as a leading end, and a trailing end unit 504, also referred to herein as a trailing end, has fully crossed a mark on a route or if the vehicle is positioned between a first mark on the route and a second mark on the route, according to at least one example of the present disclosure. The system may include a first measurement device 506 located at the leading end unit, a second measurement device 508 located at the trailing end unit, and a control circuit 510 communicably coupled to the first and second measurement devices. It shall be appreciated that the control circuit of FIG. 5 may be the same as the control circuit of FIG. 1. As shown in FIG. 5, the control circuit may be located at the leading end unit, according to at least one example of the present disclosure. However, according to at least one example of the present disclosure, the control circuit may be located elsewhere on the vehicle or, alternatively, off-vehicle at a remote location. The system may further include a first transmitter 512 and a first receiver 514 located at the leading end unit, and a second transmitter 516 and a second receiver 518 located at the trailing end unit. Altogether, the first transmitter, the first receiver, the second transmitter, and the second receiver may facilitate communication between the leading end unit and the trailing end unit, and, specifically, the first measurement device and the second measurement device. Additionally, or alternatively, the first transmitter, the first receiver, the second transmitter, and the second receiver may facilitate communication between the leading end unit (e.g., the first measurement device), the trailing end unit (e.g., the second measurement device), and the control circuit.

According to at least one example of the present disclosure, the control circuit may be configured to collect first navigation data corresponding to the leading end unit as the vehicle travels along the route. The first navigation data may be measured by the first measurement device. The control circuit may be further configured to collect second navigation data corresponding to the trailing end unit as the vehicle travels along the route. The second navigation data may be measured by the second measurement device. The control circuit may be further configured to determine that the leading end has crossed the mark on the route. The control circuit may be further configured to extract final navigation data from the collected first navigation data based on the determination that the leading end has crossed the mark. The final navigation data may correspond to the leading end unit when the leading end unit crossed the mark. The control circuit may be further configured to compare the final navigation data to the collected second navigation data. The control may be further configured to determine whether the vehicle has fully crossed the mark based on a comparison of the final navigation data with a portion of the collected second navigation data.

According to at least one example of the present disclosure, the system may further include a rolling memory buffer, and the control circuit may be further configured to store the first and second navigation data in the rolling memory buffer. As a result, the first and second navigation data may be temporarily stored, ensuring that the control circuit may access and process the first and second navigation data efficiently and without delay. Furthermore, as the first and second navigation data is collected, it may replace previously collected first and second navigation data, respectively, in the rolling memory buffer that is no longer needed by, or necessary to, the control circuit, or the system as a whole.

According to at least one example of the present disclosure, the first navigation data may include at least one of spatial coordinates, a magnetic heading, a Global Positioning System (GPS) location, a speed, angle-of-turn data, or the like of the leading end unit as the vehicle travels along the route. Additionally, the second navigation data may include at least one of spatial coordinates, a magnetic heading, a GPS location, a speed, angle-of-turn data, or the like of the trailing end unit as the vehicle travels along the route. Furthermore, the final navigation data may include at least one of spatial coordinates, a magnetic heading, a GPS location, a speed, angle-of-turn data, or the like of the leading end unit when the leading end unit crossed the mark.

According to at least one example of the present disclosure, the first measurement device may include a first precision location device configured to record at least one of the spatial coordinates, the magnetic heading, the GPS location, the speed, the angle-of-turn data, or the like of the leading end unit. Additionally, the second measurement device may include a second precision location device configured to record at least one of the spatial coordinates, the magnetic heading, the GPS location, the speed, the angle-of-turn data, or the like of the trailing end unit. The first and second precision location devices may include at least one of an accelerometer, a compass, a magnetometer, a GPS, an inertial measurement unit (IMU), a barometer, a proximity sensor, a light detection and ranging (LiDAR) device, an ultrasonic sensor, a radio-frequency identification (RFID) device, an ultra-wideband (UWB) device, a near-field communication (NFC) device, an infrared sensor, or the like. It shall be appreciated that various other precision location devices may be readily apparent to one having ordinary skill in the art and, thus, may be implemented into the system of FIG. 5 to accurately record the first and second navigation data.

According to at least one example of the present disclosure, the control circuit may be further configured to compare the speed of the leading end unit as the vehicle travels along the route to the speed of the trailing end unit as the vehicle travels along the route to properly compare the final navigation data to the collected second navigation data.

In other words, if the vehicle travels along the route at a first speed and then slows to a second speed, the number of data points gathered at the leading end unit (e.g., first navigation data) for a portion of the route may differ from the number of data points gathered at the trailing end unit (e.g., second navigation data) for the same portion of the route. As a result, it may be beneficial to compare the speed of the leading end unit to the speed of the trailing end unit to properly compare the first navigation data and, thus, the final navigation data to the second navigation data.

For example, if a leading end unit travels along a route from point A to point B at a first speed and a trailing end unit travels along the route from point A to point B at a second speed, where the second speed is half of the first speed, the trailing end unit may gather twice as many data points compared to the leading end unit. As a result, and to properly compare the first navigation data, and thus the final navigation data, of the leading end unit and the second navigation data of the trailing end unit, it may be beneficial to compare every other data point of the second navigation data with the first navigation data.

According to at least one example of the present disclosure, the system may further include at least one of a camera, an RFID device, a laser, an acoustic transducer, a GPS, or the like, such as the precision location devices previously disclosed in the present disclosure, to assist the determination that the leading end has crossed the mark. According to at least one example of the present disclosure, the determination that the leading end has crossed the mark may be automatic based on the at least one camera, RFID device, laser, acoustic transducer, GPS, or the like determining the leading end unit crossed the mark. For example, the camera may identify the mark, the RFID device may identify an RFID tag located on the mark, the laser or acoustic tranducer may use a laser beam or sound waves, or the like, respectively, to measure a distance to the mark, and the GPS may identify a precise location of the vehicle relative to a known precise location of the mark. As a result, each of the camera, the RFID device, the laser, the acoustic transducer, the GPS, or the like may determine that the leading end unit crossed the mark according to various methodologies.

Alternatively, and according to at least one example of the present disclosure, the determination that the leading end has crossed the mark may be manual based on a user determining that the leading end crossed the mark. For example, the user may visually determine that the leading end unit has crossed the mark. In another example, the user may manually determine that the leading end has crossed the mark based on a manual, or automated, analysis of data, such as data received from at least one of a camera, an RFID device, a laser, an acoustic transducer, a GPS, or the like, such as the precision location devices previously disclosed in the present disclosure.

According to at least one example of the present disclosure, the control circuit may be further configured to generate at least one of a visual alert or an audible alert based on the determination whether the vehicle has fully crossed the mark, where the at least one visual or audible alert may indicate whether the vehicle has fully crossed the mark. The visual alert, for example, may include illuminating a lightbulb, such as a colored light bulb, or displaying a color block, text, or the like on a display available to a user, such as an operator, an engineer, or the like, located onboard the vehicle or at a remote location capable of controlling the vehicle. For example, a green lightbulb may be illuminated, or a green color block and/or text may be displayed to the user, to indicate the vehicle has fully crossed the mark. Alternatively, a red lightbulb may be illuminated, or a red color block and/or text may be displayed to the user, to indicate the vehicle has not fully crossed the mark. The audible alert, for example, may include a voiceover announcing whether the vehicle has fully crossed the mark. It shall be appreciated that various other visual and audible alerts may be readily apparent to one having ordinary skill in the art and, thus, may be implemented into the system of FIG. 5 to indicate whether the vehicle has fully crossed the mark.

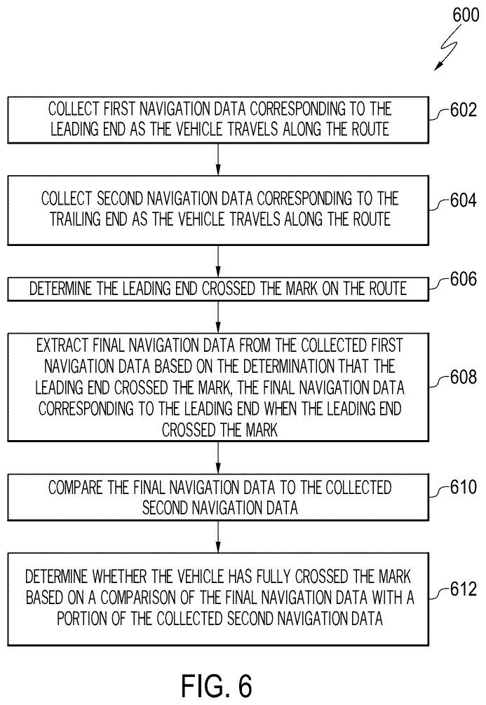

FIG. 6 is a flow diagram of a method 600 for determining whether a vehicle having a leading end unit, also referred to herein as a leading end, and a trailing end unit, also referred to herein as a trailing end, has fully crossed a mark on a route, according to at least one example of the present disclosure. The method may include collecting 602 first navigation data corresponding to the leading end unit as the vehicle travels along the route. The method may further include collecting 604 second navigation data corresponding to the trailing end unit as the vehicle travels along the route. The method may further include determining 606 that the leading end crossed the mark on the route. The method may further include extracting 608 final navigation data from the collected first navigation data based on the determination that the leading end crossed the mark, where the first navigation data may correspond to the leading end unit when the leading end unit crossed the mark. The method may further include comparing 610 the final navigation data to the collected second navigation data. The method may further include determining 612 whether the vehicle has fully crossed the mark based on a comparison of the final navigation data with a portion of the collected second navigation data.

According to at least one example of the present disclosure, the method may further include storing the first and second navigation data in a rolling memory buffer. As a result, the first and second navigation data may be temporarily stored, ensuring that the first and second navigation data may be accessed, and processed, efficiently and without delay. Furthermore, as the first and second navigation data is collected, it may replace previously collected first and second navigation data, respectively, in the rolling memory buffer that is no longer needed, or necessary.

According to at least one example of the present disclosure, the first navigation data may include at least one of spatial coordinates, a magnetic heading, a GPS location, a speed, angle-of-turn data, or the like of the leading end unit as the vehicle travels along the route. Additionally, the second navigation data may include at least one of spatial coordinates, a magnetic heading, a GPS location, a speed, angle-of-turn data, or the like of the trailing end unit as the vehicle travels along the route. Furthermore, the final navigation data may include at least one of spatial coordinates, a magnetic heading, a GPS location, a speed, angle-of-turn data, or the like of the leading end unit when the leading end unit crossed the mark.

According to at least one example of the present disclosure, the method may further include comparing the speed of the leading end unit as the vehicle travels along the route to the speed of the trailing end unit as the vehicle travels along the route to properly compare the final navigation data to the collected second navigation data.

In other words, if the vehicle travels along the route at a first speed and then slows to a second speed, the number of data points gathered at the leading end unit (e.g., first navigation data) for a portion of the route may differ from the number of data points gathered at the trailing end unit (e.g., second navigation data) for the same portion of the route. As a result, it may be beneficial to compare the speed of the leading end unit to the speed of the trailing end unit to properly compare the first navigation data and, thus, the final navigation data to the second navigation data.

For example, if a leading end unit travels along a route from point A to point B at a first speed and a trailing end unit travels along the route from point A to point B at a second speed, where the second speed is half of the first speed, the trailing end unit may gather twice as many data points compared to the leading end unit. As a result, and to properly compare the first navigation data, and thus the final navigation data, of the leading end unit and the second navigation data of the trailing end unit, it may be beneficial to compare every other data point of the second navigation data with the first navigation data.

According to at least one example of the present disclosure, the determination that the leading end crossed the mark may be automatic based on at least one of a camera, an RFID device, a laser, an acoustic transducer, a GPS device, or the like, such as the precision location devices previously disclosed in the present disclosure, determining the leading end unit crossed the mark. For example, the camera may identify the mark, the RFID device may identify an RFID tag located on the mark, the laser or acoustic tranducer may use a laser beam or sound waves, or the like, respectively, to measure a distance to the mark, and the GPS may identify a precise location of the vehicle relative to a known precise location of the mark. As a result, each of the camera, the RFID device, the laser, the acoustic transducer, the GPS, or the like may determine that the leading end unit crossed the mark according to various methodologies.

Alternatively, and according to at least one example of the present disclosure, the determination that the leading end crossed the mark may be manual based on a user determining the leading end unit crossed the mark. For example, the user may visually determine that the leading end unit has crossed the mark. In another example, the determination that the leading end crossed the mark may be manual based on a manual, or automated, analysis of data, such as data received from at least one of a camera, an RFID device, a laser, an acoustic transducer, a GPS, or the like, such as the precision location devices previously disclosed in the present disclosure.

According to at least one example of the present disclosure, the method may further include generating at least one of a visual alert or an audible alert based on the determination whether the vehicle has fully crossed the mark, where the at least one visual or audible alert may indicate whether the vehicle has fully crossed the mark. The visual alert, for example, may include illuminating a lightbulb, such as a colored light bulb, or displaying a color block, text, or the like on a display available to a user, such as an operator, an engineer, or the like, located onboard the vehicle or at a remote location capable of controlling the vehicle. For example, a green lightbulb may be illuminated, or a green color block and/or text may be displayed to the user, to indicate the vehicle has fully crossed the mark. Alternatively, a red lightbulb may be illuminated, or a red color block and/or text may be displayed to the user, to indicate the vehicle has not fully crossed the mark. The audible alert, for example, may include a voiceover announcing whether the vehicle has fully crossed the mark. It shall be appreciated that various other visual and audible alerts may be readily apparent to one having ordinary skill in the art and, thus, may be implemented into the method of FIG. 6 to indicate whether the vehicle has fully crossed the mark.

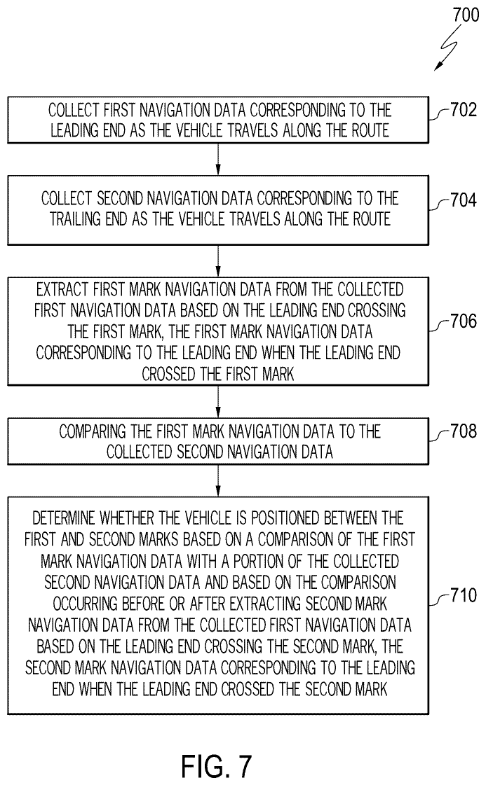

FIG. 7 is a flow diagram of a method 700 for determining whether a vehicle having a leading end unit, also referred to herein as a leading end, and a trailing end unit, also referred to herein as a trailing end, is positioned between a first mark on a route and a second mark on the route, according to at least one example of the present disclosure. The method may include collecting 702 first navigation data corresponding to the leading end unit as the vehicle travels along the route. The method may further include collecting 704 second navigation data corresponding to the trailing end unit as the vehicle travels along the route. The method may further include extracting 706 first mark navigation data from the collected first navigation data based on the leading end unit crossing the first mark, where the first mark navigation data may correspond to the leading end unit when the leading end unit crossed the first mark. The method may further include comparing 708 the first mark navigation data to the collected second navigation data. The method may further include determining 710 whether the vehicle is positioned between the first and second marks based on a comparison of the first mark navigation data with a portion of the collected second navigation data, and further based on the comparison occurring before or after extracting second mark navigation data from the collected first navigation data based on the leading end unit crossing the second mark, where the second mark navigation data may correspond to the leading end unit when the leading end unit crossed the second mark.

According to at least one example of the present disclosure, the method may further include storing the first and second navigation data in a rolling memory buffer. As a result, the first and second navigation data may be temporarily stored, ensuring that the first and second navigation data may be accessed, and processed, efficiently and without delay. Furthermore, as the first and second navigation data is collected, it may replace previously collected first and second navigation data, respectively, in the rolling memory buffer that is no longer needed, or necessary.

According to at least one example of the present disclosure, the first navigation data may include at least one of spatial coordinates, a magnetic heading, a GPS location, a speed, angle-of-turn data, or the like of the leading end unit as the vehicle travels along the route. Additionally, the second navigation data may include at least one of spatial coordinates, a magnetic heading, a GPS location, a speed, angle-of-turn data, or the like of the trailing end unit as the vehicle travels along the route. Furthermore, the first mark navigation data may include at least one of spatial coordinates, a magnetic heading, a GPS location, a speed, angle-of-turn data, or the like of the leading end unit when the leading end unit crossed the first mark. Additionally, the second mark navigation data may include at least one of spatial coordinates, a magnetic heading, a GPS location, a speed, angle-of-turn data, or the like of the trailing end unit when the trailing end unit crossed the second mark.

According to at least one example of the present disclosure, the method may further include comparing the speed of the leading end unit as the vehicle travels along the route to the speed of the trailing end unit as the vehicle travels along the route to properly compare the first mark navigation data to the collected second navigation data.

In other words, if the vehicle travels along the route at a first speed and then slows to a second speed, the number of data points gathered at the leading end unit (e.g., first navigation data) for a portion of the route may differ from the number of data points gathered at the trailing end unit (e.g., second navigation data) for the same portion of the route. As a result, it may be beneficial to compare the speed of the leading end unit to the speed of the trailing end unit to properly compare the first navigation data and, thus, the first mark navigation data to the second navigation data.

For example, if a leading end unit travels along a route from point A to point B at a first speed and a trailing end unit travels along the route from point A to point B at a second speed, where the second speed is half of the first speed, the trailing end unit may gather twice as many data points compared to the leading end unit. As a result, and to properly compare the first navigation data, and thus the first mark navigation data, of the leading end unit and the second navigation data of the trailing end unit, it may be beneficial to compare every other data point of the second navigation data with the first navigation data.

According to at least one aspect of the present disclosure, the method may further include generating at least one of a visual alert or an audible alert based on the determination whether the vehicle is positioned between the first and second marks. The at least one visual or audible alert may indicate whether the vehicle is positioned between the first and second marks. The visual alert, for example, may include illuminating a lightbulb, such as a colored light bulb, or displaying a color block, text, or the like on a display available to a user, such as an operator, an engineer, or the like, located onboard the vehicle or at a remote location capable of controlling the vehicle. For example, a green lightbulb may be illuminated, or a green color block and/or text may be displayed to the user, to indicate the vehicle is positioned between the first and second marks. Alternatively, a red lightbulb may be illuminated, or a red color block and/or text may be displayed to the user, to indicate the vehicle is not positioned between the first and second marks. The audible alert, for example, may include a voiceover announcing whether the vehicle is positioned between the first and second marks. It shall be appreciated that various other visual and audible alerts may be readily apparent to one having ordinary skill in the art and, thus, may be implemented into the method of FIG. 7 to indicate whether the vehicle is positioned between the first and second marks.

According to at least one aspect of the present disclosure, the method may further include determining that the leading end crossed the first mark on the route. According to at least one example of the present disclosure, the determination that the leading end crossed the first mark on the route may be manual based on a user determining that the leading end unit crossed the first mark. For example, the determination that the leading end crossed the first mark may be manual based on a user visually determining that the leading end crossed the first mark. In another example, the determination that the leading end crossed the first mark may be manual based on a manual, or automated, analysis of data, such as data received from at least one of a camera, an RFID device, a laser, an acoustic transducer, a GPS, or the like, such as the precision location devices previously disclosed in the present disclosure.

Alternatively, and according to at least one example of the present disclosure, the determination that the leading end crossed the first mark may be automatic based on at least one of a camera, an RFID device, a laser, an acoustic transducer, a GPS device, or the like, such as the precision location devices previously disclosed in the present disclosure, determining that the leading end unit crossed the first mark. For example, the camera may identify the first mark, the RFID device may identify an RFID tag located on the first mark, the laser or acoustic tranducer may use a laser beam or sound waves, or the like, respectively, to measure a distance to the first mark, and the GPS may identify a precise location of the vehicle relative to a known precise location of the first mark. As a result, each of the camera, the RFID device, the laser, the acoustic transducer, the GPS, or the like may determine that the leading end unit crossed the first mark according to various methodologies.

According to at least one example of the present disclosure, the control circuit of FIG. 5 may be configured to perform each of the functions of the method of FIG. 6, each of the functions of the method of FIG. 7, or any combinations thereof.

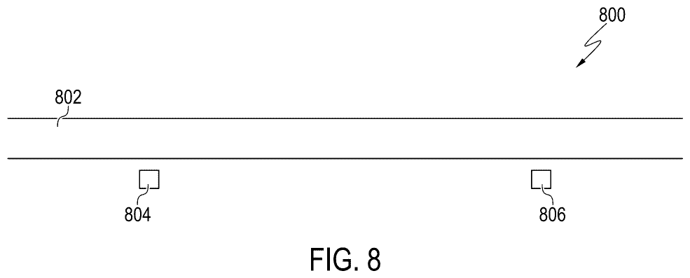

FIG. 8 illustrates an example route section 800 having a route section 802, as well as a first mark 804 and a second mark 806, according to at least one example of the present disclosure.

Referring again to FIGS. 5-7, with continued reference to FIG. 8, and according to at least one example of the present disclosure, the system of FIG. 5 and the method of FIG. 6 may determine whether a vehicle has fully crossed the first mark of FIG. 8. Additionally, or alternatively, the system of FIG. 5 and the method of FIG. 6 may determine whether a vehicle has fully crossed the second mark of FIG. 8. Furthermore, the method of FIG. 7 may determine whether a vehicle is positioned between the first mark of FIG. 8 and the second mark of FIG. 8.

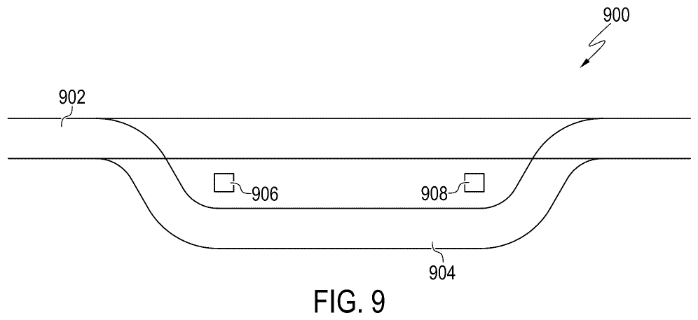

FIG. 9 illustrates an example route section 900 having a first route section 902 and a second route section 904, the second route section having a first mark 906 and a second mark 908, according to at least one example of the present disclosure.

Referring again to FIGS. 5-7, with continued reference to FIG. 9, and according to at least one example of the present disclosure, the system of FIG. 5 and the method of FIG. 6 may determine whether a vehicle positioned on the second route section of FIG. 9 has fully crossed the first mark of FIG. 9. Additionally, or alternatively, the system of FIG. 5 and the method of FIG. 6 may determine whether a vehicle positioned on the second route section of FIG. 9 has fully crossed the second mark of FIG. 9. Furthermore, the method of FIG. 7 may determine whether a vehicle positioned on the second route section of FIG. 9 is positioned between the first mark of FIG. 9 and the second mark of FIG. 9.

Although FIGS. 8 and 9 illustrate example route sections having specific geometries, it shall be appreciated that the system of FIG. 5 and the methods of FIGS. 6 and 7 may be applicable to any geometry of any route section so long as the route section includes a mark, or a first mark and a second mark. In other words, the first route section may not be parallel to the second route section, and the first mark may not be inline with the second mark.

According to at least one example of the present disclosure, and with specific reference to each of FIGS. 5-9, the systems and methods disclosed herein may not detect a physical fouling mark, or marks. Rather, the systems and methods disclosed herein may detect vehicle fouling without detecting a physical fouling mark, or marks. For example, as used herein, reference to “the mark,” “the first mark,” or “the second mark,” may not refer to a physical fouling mark, or marks, installed alongside a route. Instead, “the mark,” “the first mark,” or “the second mark” may refer to a specific location, or locations, along the route that is not physically marked by a fouling mark, or marks. Accordingly, the systems and methods disclosed herein may detect vehicle fouling with respect to a specific location, or locations, without a physical fouling mark, or marks, being installed alongside the route and/or visible to a human crew member of the vehicle.

The singular forms “a”, “an”, and “the” include plural references unless the context clearly dictates otherwise. “Optional” or “optionally” means that the subsequently described event or circumstance may or may not occur, and that the description may include instances where the event occurs and instances where it does not. Approximating language, as used herein, may be applied to modify any quantitative representation that could permissibly vary without resulting in a change in the basic function to which it may be related. Accordingly, a value modified by a term or terms, such as “about,” “substantially,” and “approximately,” may be not to be limited to the precise value specified. In at least some instances, the approximating language may correspond to the precision of an instrument for measuring the value. Here and throughout the specification, range limitations may be combined and/or interchanged, such ranges may be identified and include all the sub-ranges contained therein unless context or language indicates otherwise.

As used in the present disclosure, the term substantially may include ±5° deviations. In other words, a first axis is considered to be substantially parallel to a second axis when such first axis is within a ±5° deviation of the second axis.

This written description uses examples to disclose the examples, including the best mode, and to enable a person of ordinary skill in the art to practice the examples, including making and using any devices or systems and performing any incorporated methods.

What is claimed is:

1. A system for determining whether a vehicle has fully crossed a mark on a route, the vehicle having a leading end and a trailing end, the system comprising:
a first measurement device located at the leading end;
a second measurement device located at the trailing end; and
a control circuit communicably coupled to the first and second measurement devices, the control circuit configured to:
collect first navigation data corresponding to the leading end as the vehicle travels along the route, the first navigation data measured by the first measurement device;
collect second navigation data corresponding to the trailing end as the vehicle travels along the route, the second navigation data measured by the second measurement device;
determine the leading end crossed the mark on the route;
extract final navigation data from the collected first navigation data based on the determination that the leading end crossed the mark, the final navigation data corresponding to the leading end when the leading end crossed the mark;
compare the final navigation data to the collected second navigation data; and
determine whether the vehicle has fully crossed the mark based on a comparison of the final navigation data with a portion of the collected second navigation data.

2. The system of claim 1, further comprising a rolling memory buffer, wherein the control circuit is further configured to store the first and second navigation data in the rolling memory buffer.

3. The system of claim 1, wherein:
the first navigation data comprises at least one of spatial coordinates, a magnetic heading, a Global Positioning System (GPS) location, or a speed of the leading end as the vehicle travels along the route;
the second navigation data comprises at least one of spatial coordinates, a magnetic heading, a GPS location, or a speed of the trailing end as the vehicle travels along the route; and
the final navigation data comprises at least one of spatial coordinates, a magnetic heading, a GPS location, or a speed of the leading end when the leading end crossed the mark.

4. The system of claim 3, wherein the control circuit is further configured to compare the speed of the leading end as the vehicle travels along the route to the speed of the trailing end as the vehicle travels along the route to properly compare the final navigation data to the collected second navigation data.

5. The system of claim 1, further comprising at least one of a camera, a radio-frequency identification (RFID) device, a laser, an acoustic transducer, or a Global Positioning System (GPS) device, and wherein the determination that the leading end crossed the mark is automatic based on the at least one camera, RFID device, laser, acoustic transducer, or GPS device determining that the leading end crossed the mark.

6. The system of claim 1, wherein the determination that the leading end crossed the mark is manual based on a user determining that the leading end crossed the mark.

7. The system of claim 1, wherein the control circuit is further configured to generate at least one of a visual alert or an audible alert based on the determination whether the vehicle has fully crossed the mark, the at least one visual or audible alert indicating whether the vehicle has fully crossed the mark.

8. A method for determining whether a vehicle has fully crossed a mark on a route, the vehicle having a leading end and a trailing end, the method comprising:
collecting first navigation data corresponding to the leading end as the vehicle travels along the route;
collecting second navigation data corresponding to the trailing end as the vehicle travels along the route;
determining the leading end crossed the mark on the route;
extracting final navigation data from the collected first navigation data based on the determination that the leading end crossed the mark, the final navigation data corresponding to the leading end when the leading end crossed the mark;
comparing the final navigation data to the collected second navigation data; and
determining whether the vehicle has fully crossed the mark based on a comparison of the final navigation data with a portion of the collected second navigation data.

9. The method of claim 8, further comprising storing the first and second navigation data in a rolling memory buffer.

10. The method of claim 8, wherein:
the first navigation data comprises at least one of spatial coordinates, a magnetic heading, a Global Positioning System (GPS) location, or a speed of the leading end as the vehicle travels along the route;
the second navigation data comprises at least one of spatial coordinates, a magnetic heading, a GPS location, or a speed of the trailing end as the vehicle travels along the route; and
the final navigation data comprises at least one of spatial coordinates, a magnetic heading, a GPS location, or a speed of the leading end when the leading end crossed the mark.

11. The method of claim 10, further comprising comparing the speed of the leading end as the vehicle travels along the route to the speed of the trailing end as the vehicle travels along the route to properly compare the final navigation data to the collected second navigation data.

12. The method of claim 8, wherein determining that the leading end crossed the mark is automatic based on at least one of a camera, a radio-frequency identification (RFID) device, a laser, an acoustic transducer, or a Global Positioning System (GPS) device determining that the leading end crossed the mark.

13. The method of claim 8, wherein determining that the leading end crossed the mark is manual based on a user determining the leading end crossed the mark.

14. The method of claim 8, further comprising generating at least one of a visual alert or an audible alert based on the determination whether the vehicle has fully crossed the mark, the at least one visual or audible alert indicating whether the vehicle has fully crossed the mark.

15. A method for determining whether a vehicle is positioned between a first mark on a route and a second mark on the route, the vehicle having a leading end and a trailing end, the method comprising:
collecting first navigation data corresponding to the leading end as the vehicle travels along the route;
collecting second navigation data corresponding to the trailing end as the vehicle travels along the route;
extracting first mark navigation data from the collected first navigation data based on the leading end crossing the first mark, the first mark navigation data corresponding to the leading end when the leading end crossed the first mark;
comparing the first mark navigation data to the collected second navigation data; and
determining whether the vehicle is positioned between the first and second marks based on a comparison of the first mark navigation data with a portion of the collected second navigation data and based on the comparison occurring before or after extracting second mark navigation data from the collected first navigation data based on the leading end crossing the second mark, the second mark navigation data corresponding to the leading end when the leading end crossed the second mark.

16. The method of claim 15, further comprising storing the first and second navigation data in a rolling memory buffer.

17. The method of claim 15, wherein:
the first navigation data comprises at least one of spatial coordinates, a magnetic heading, a Global Positioning System (GPS) location, or a speed of the leading end as the vehicle travels along the route;
the second navigation data comprises at least one of spatial coordinates, a magnetic heading, a GPS location, or a speed of the trailing end as the vehicle travels along the route;
the first mark navigation data comprises at least one of spatial coordinates, a magnetic heading, a GPS location, or a speed of the leading end when the leading end crossed the first mark; and
the second mark navigation data comprises at least one of spatial coordinates, a magnetic heading, a GPS location, or a speed of the leading end when the leading end crossed the second mark.

18. The method of claim 17, further comprising comparing the speed of the leading end as the vehicle travels along the route to the speed of the trailing end as the vehicle travels along the route to properly compare the first mark navigation data to the collected second navigation data.

19. The method of claim 15, further comprising generating at least one of a visual alert or an audible alert based on the determination whether the vehicle is positioned between the first and second marks, the at least one visual or audible alert indicating whether the vehicle is positioned between the first and second marks.

20. The method of claim 15, further comprising determining the leading end crossed the first mark on the route, wherein determining the leading end crossed the first mark is manual based on a user determining the leading end crossed the first mark or automatic based on at least one of a camera, a radio-frequency identification (RFID) device, a laser, an acoustic transducer, or a Global Positioning System (GPS) device determining the leading end crossed the first mark.
